(19) United States
(12) Patent Application Publication
(10) Pub. No.: US 2026/0199068 A1
(43) Pub. Date: Jul. 16, 2026

(54) ORAL CARE APPARATUS AND APPARATUS WITH FLUID PUMPING MECHANISM

(71) Applicant: Shenzhen Soocas Technology Co., Ltd., Shenzhen (CN)

(72) Inventor: Zhoujian LI, Shenzhen (CN)

(73) Assignee: Shenzhen Soocas Technology Co., Ltd., Shenzhen (CN)

(21) Appl. No.: 19/427,525

(22) Filed: Dec. 19, 2025

Related U.S. Application Data
(63) Continuation of application No. PCT/CN2025/114233, filed on Aug. 12, 2025.

(30) Foreign Application Priority Data
Dec. 25, 2024 (CN) 2024119602336

(51) Int. Cl. A61C 17/024

(52) U.S. Cl. CPC A61C 17/024

(57) ABSTRACT

The present disclosure discloses an oral care apparatus and an apparatus with a fluid pumping mechanism, where the oral care apparatus at least includes a main housing, a fluid pumping mechanism, and an electronic device. The main housing has a main body chamber, the fluid pumping mechanism is arranged inside the main body chamber, and the fluid pumping mechanism includes a housing component, where an outer surface of the housing component and the main housing enclose to form a first space. The electronic device is arranged within the first space. The main housing is provided with an interactive port, and at least part of space inside the main body chamber communicates with external environment through the interactive port, such that a moist fluid inside the main body chamber is discharged to the external environment through the interactive port.

### CROSSREFERENCE TO RELATED APPLICATION

This application is a continuation of International Application No. PCT/CN2025/114233, filed on August 12, 2025, which claims priority to Chinese Patent Application No.2024119602336 titled "ORAL CARE APPARATUS AND APPARATUS WITH FLUID PUMPING MECHANISM" and filed to the State Patent Intellectual Property Office on December 25, 2024, the entire contents of which are incorporated herein by reference.

### TECHNICAL FIELD

The present disclosure relates to the field of oral care technology, and more particularly, to an oral care apparatus and an apparatus with a fluid pumping mechanism.

### BACKGROUND

An oral care apparatus with an oral flushing function typically is provided with a pump body, such that a liquid is pumped from a water tank through the pump body to output water flow impact to a user's oral cavity for oral cleaning.

However, during use of the pump body, leakage of water vapor may increase air humidity, and even liquid leakage may be caused, which may cause corrosion and damage to electronic devices such as batteries or circuit boards in the oral care apparatus.

### SUMMARY

Objectives of the present disclosure are to provide an oral care apparatus and an apparatus with a fluid pumping mechanism.

To achieve the above objectives, in one aspect the present disclosure provides an oral care apparatus, which at least includes a main housing, a fluid pumping mechanism, and an electronic device. The main housing has a main body chamber, the fluid pumping mechanism is arranged inside the main body chamber, and the fluid pumping mechanism includes a housing component, where an outer surface of the housing component and the main housing enclose to form a first space. The electronic device is arranged within the first space. The main housing is provided with an interactive port, and at least part of space inside the main body chamber communicates with external environment through the interactive port, such that a moist fluid inside the main body chamber is discharged to the external environment through the interactive port.

To achieve the above objectives, in another aspect the present disclosure also provides an apparatus with a fluid pumping mechanism, comprising a main housing, a fluid pumping mechanism, and an electronic device, where the main housing has a main body chamber. The fluid pumping mechanism includes a housing component, where an outer surface of the housing component and the main housing enclose to form a first space. The electronic device is arranged within the first space. The main housing is provided with an interactive port, and at least part of space inside the main body chamber communicates with external environment through the interactive port, such that a moist fluid inside the main body chamber is discharged to the external environment through the interactive port.

### BRIEF DESCRIPTION OF THE DRAWINGS

To describe the technical solutions in the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic half-sectional view of a liquid supply base station according to an embodiment of the present disclosure;

FIG. 2 is a schematic exploded view of a liquid supply base station according to an embodiment of the present disclosure;

FIG. 3 is a schematic half-sectional view of a liquid supply base station according to another embodiment of the present disclosure;

FIG. 4 is a schematic half-sectional view of a fluid pumping mechanism according to an embodiment of the present disclosure;

FIG. 5 is a schematic half-sectional view of an oral irrigator according to an embodiment of the present disclosure;

FIG. 6 is a schematic perspective view of a fluid pumping mechanism according to an embodiment of the present disclosure;

FIG. 7 is a schematic exploded view of a fluid pumping mechanism according to an embodiment of the present disclosure;

FIG. 8 is a schematic exploded view showing a partial structure of a fluid pumping mechanism according to an embodiment of the present disclosure;

FIG. 9 is a schematic perspective view of a first housing piece according to an embodiment of the present disclosure;

FIG. 10 is a schematic exploded view showing another partial structure of a fluid pumping mechanism according to an embodiment of the present disclosure;

FIG. 11 is a schematic half-sectional view of an oral irrigator according to another embodiment of the present disclosure;

FIG. 12 is a schematic half-sectional view of an oral irrigator according to still another embodiment of the present disclosure;

FIG. 13 is a schematic half-sectional view showing a partial structure of an oral irrigator according to still another embodiment of the present disclosure;

FIG. 14 is a schematic exploded view showing a partial structure of an oral irrigator according to still another embodiment of the present disclosure; and

FIG. 15 is a schematic exploded view showing another partial structure of an oral irrigator according to still another embodiment of the present disclosure.

Reference numerals in the accompanying drawings:

main housing 100; main body portion 101; lower cover 102; upper cover 103; main body chamber 110; first space 111; second space 112; third space 113; fourth space 114; interactive port 120;

fluid pumping mechanism 200; housing component 210; execution cavity 211; transmission cavity 212; first housing piece 213; first clearance hole 2131; wire harness connection hole 2132; second housing piece 214; drive cavity 215; first sealing element 216; second sealing element 217; communication hole 218; pump body 219; execution unit 220; drive unit 230; transmission unit 240; gear set 241; connecting rod 242; third housing piece 250; keypad hole 251;

electronic device 300; PCB board 310;

pipeline 400;

partition board 500;

water tank 600; and

keypad seal 700.

### DETAILED DESCRIPTION

At present, oral care apparatuses on the market mainly adopt three design methods to achieve an oral flushing function. The first design is a combinational design of an oral irrigator and a liquid supply base station, where the liquid supply base station is internally provided with a pump body responsible for delivering water flow to the oral irrigator to generate water flow impact. In the second design method, the oral irrigator is integrated with the pump body, enabling the apparatuses to independently provide the water flow impact without the need for an additional liquid supply base station. In the third design method, an integrated flushing machine not only integrates the flushing function, but also has a tooth brushing function. The integrated flushing machine is also integrated with the pump body to provide the required water flow impact. These design methods each have their own characteristics, can meet needs and usage scenarios of different users, but require the use of the pump body to provide the water flow impact.

However, commonly used water pumps such as a piston pump or diaphragm pump mainly pump a liquid by means of stroke and squeeze them into output pipelines, and leakage of water vapor may be caused during this process. Specifically, taking the piston pump as an example, in-depth research in the present disclosure has found that there is a cylinder liner inside the pump body, and the piston reciprocates inside the cylinder liner to suck in and discharge the liquid. During this process, the liquid may adhere to an inner wall of the cylinder liner, evaporate and form the water vapor. The water vapor enters a transmission cavity, and then diffuses outward from the transmission cavity to a motor, causing damage to the motor, and causing corrosion and damage to electronic devices such as batteries and circuit boards in the oral care apparatuses. Moreover, with the long-term operation of the piston, a sealing ring between the piston and the cylinder liner may also be damaged or deformed, leading to liquid leakage, which may also cause damage to the motor, and cause corrosion and damage to the electronic devices such as the batteries or circuit boards in the oral care apparatuses.

In the present disclosure, it is attempted to install two sealing rings on the piston to improve sealing performance between the piston and the inner wall of the cylinder liner by increasing the number of the sealing rings, thereby avoiding water leakage. But this solution also increases a friction between the piston and the cylinder liner, requires greater power to drive the piston, and still cannot prevent the liquid from adhering to the inner wall of the cylinder liner and cannot avoid evaporation and leakage.

In the present disclosure, it is also attempted to arrange an accordion folded sealing sleeve between an outer wall surface of the cylinder liner or an outer wall surface of a pump housing and a connecting rod that drives the piston to move, such that the sealing sleeve is used to isolate the liquid adhering to the inner wall of the cylinder liner from the outside, thereby preventing the liquid adhering to the inner wall of the cylinder liner from evaporating and diffusing outward. Although this solution can prevent leakage of the liquid and moisture, it is prone to causing damage and aging because the sealing sleeve needs to follow the movement of the connecting rod, resulting in a shorter service life. Moreover, after the damage and aging, the leakage may still occur and thus cause damage to the electronic devices.

Therefore, the present disclosure proposes a new improvement scheme, which can avoid entry of external moist fluids (liquids or water vapor) and can direct the leaked moist fluids from the inside to the outside, thereby preventing causing damage to the electronic devices inside the oral care apparatus. Specifically, the oral care apparatus is highly sealed as a whole to achieve spatial isolation, thereby preventing the moist fluid outside the oral care apparatus from entering the oral care apparatus. Furthermore, internal space of the oral care apparatus communicates with external environment through a through hole, such that leakage liquid and moisture inside the oral care apparatus can be timely discharged through the through hole, thereby reducing the humidity inside the oral care apparatus, avoiding causing damage to the electronic devices inside the oral care apparatus, and prolonging the service life.

To make the objectives, technical solutions, and advantages of the embodiments of the present disclosure clearer, the technical solutions in the embodiments of the present disclosure will be described clearly and completely below, in conjunction with the accompanying drawings in the embodiments of the present disclosure. Apparently, the described embodiments are some but not all of the embodiments of the present disclosure.

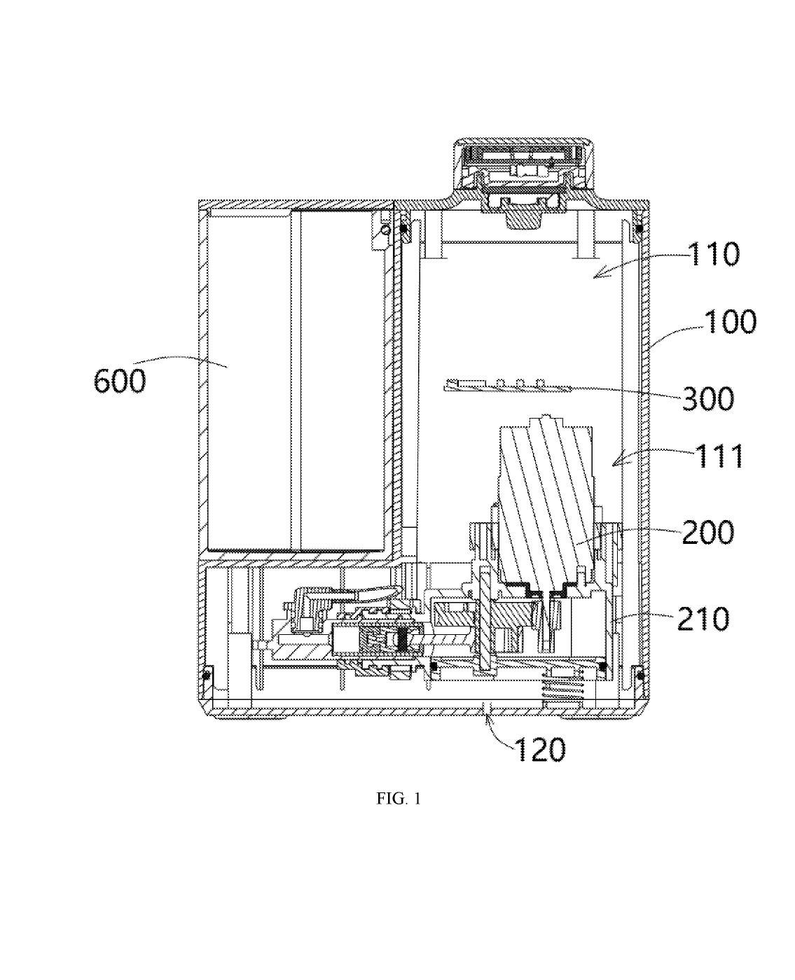

Referring to FIGS. 1 to 4, in one implementable embodiment, the oral care apparatus may at least include a main housing 100, a fluid pumping mechanism 200, and an electronic device 300. Serving as a load-bearing member of the oral care apparatus, the main housing 100 is mainly used to support and protect other components in the oral care apparatus. Specifically, the main housing 100 has a main body chamber 110, and the fluid pumping mechanism 200 is arranged inside the main body chamber 110. The fluid pumping mechanism 200 may pump a liquid through a stroke and squeeze the liquid into an output pipeline, providing kinetic energy for the liquid to transport the liquid. The fluid pumping mechanism 200 includes a housing component 210, where an outer surface of the housing component 210 and the main housing 100 enclose to form a first space 111. The electronic device 300 is arranged within the first space 111. In this way, the housing component 210 may isolate an internal component of the fluid pumping mechanism 200 from the electronic device 300 to some extent, preventing the liquid leaked out of the fluid pumping mechanism 200 from directly splashing onto the electronic device 300, thus providing a certain protective effect.

Meanwhile, considering that the fluid pumping mechanism 200 positioned inside the main body chamber 110 may experience leakage of the moist fluid, which may still lead to increase in the moist fluid inside the main body chamber 110, causing damage to a drive unit 230 of the fluid pumping mechanism 200 and the electronic device 300. Therefore, in this embodiment, the main housing 100 may be provided with an interactive port 120, and at least part of space inside the main body chamber 110 communicates with external environment through the interactive port 120, such that the moist fluid inside the main body chamber 110 may be discharged to the external environment through the interactive port 120, thereby reducing the humidity inside the main body chamber 110, avoiding causing damage to the drive unit 230 of the fluid pumping mechanism 200 and the electronic device 300, and thus further prolonging the service life of the oral care apparatus.

It should be pointed out that the interactive port 120 does not have a filtering function. The interactive port 120 not only may allow the moist fluid inside the main body chamber 110 to be discharged to the external environment, but also may allow dry gas inside the main body chamber 110 and dry gas in the external environment to pass through. The oral care apparatus refers to an apparatus that is integrated with the fluid pumping mechanism 200 and is used for oral care. The oral care apparatus may include, but is not limited to, a liquid supply base station in the combinational design of the oral irrigator and the liquid supply base station, the oral irrigator integrated with the fluid pumping mechanism, and the integrated flushing machine.

In practical applications, the electronic device 300 may include, but is not limited to, one or more of a battery, a PCB board 310, a motor, and a display screen.

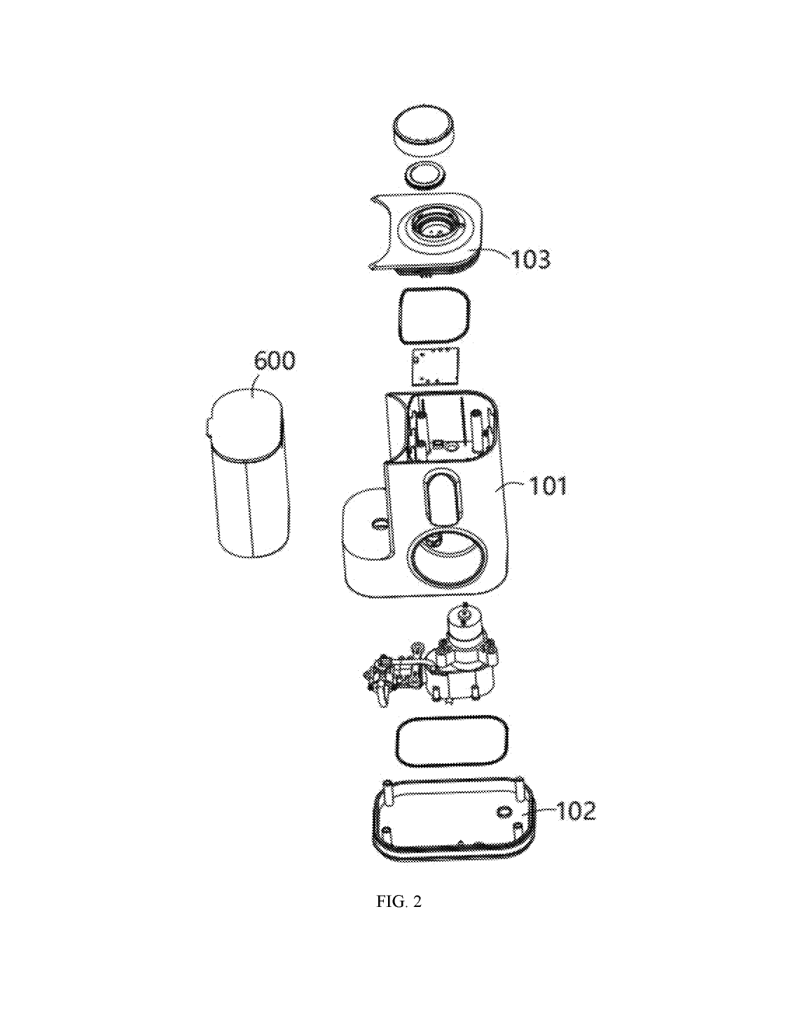

The main body chamber 110 communicates with the external environment through the interactive port 120. In addition, remainders of the main housing 100 may be sealed, to isolate the main body chamber 110 from the external environment as much as possible, thereby achieving dry-wet separation. In this way, the moisture from the external environment is prevented from entering the main body chamber 110 by means of the main housing 100, thereby avoiding aggravating the moisture inside the main body chamber 110, which may cause damage to the drive unit 230 of the fluid pumping mechanism 200 and the electronic device 300. The main housing 100 may have different ways in forming the relatively sealed main body chamber 110, depending on different types of the oral care apparatus. Taking an example where the oral care apparatus is the liquid supply base station, as shown in FIGS. 1 and 2, the main housing 100 may include a main body portion 101 having an upper opening and a lower opening, a lower cover 102, and an upper cover 103. The lower cover 102 is arranged at the lower opening of the main body portion 101, and the upper cover 103 is arranged at the upper opening of the main body portion 101. The lower cover 102 and the upper cover 103 may be separately sealed with the main body portion 101 by means of a sealing element or adhesive seal, such that the main body portion 101, the lower cover 102 and the upper cover 103 jointly enclose to form the relatively sealed main body chamber 110. The upper cover 103 may also be provided with an adjustment button, but an assembly gap between the adjustment button and the upper cover 103 also needs to be sealed, to ensure high sealing performance of the main body chamber 110. Taking an example where the oral care apparatus is the oral irrigator integrated with the fluid pumping mechanism 200, as shown in FIG. 5, the main housing 100 of the oral irrigator forms a grip handle. The main housing 100 may at least include the main body portion 101 having the upper opening and the upper cover 103, where the upper cover 103 is arranged at the upper opening of the main body portion 101. A sealing element or adhesive seal is applied between the upper cover 103 and the main body portion 101, such that the main body portion 101 and the upper cover 103 jointly enclose to form the relatively sealed main body chamber 110. The upper cover 103 may be provided with a plug connector for connecting a nozzle, and an assembly gap between the plug connector and the upper cover 103 also needs to be sealed, to ensure the high sealing performance of the main body chamber 110.

It is worth mentioning that in the present disclosure, the main body chamber 110 is sealed to a certain extent by means of the main housing 100, to achieve the spatial isolation, thereby reducing possibility of the moist fluid in the external environment entering the main body chamber 110. Furthermore, at least part of the space inside the main body chamber 110 communicates with the external environment through the interactive port 120, such that the moist fluid inside the main body chamber 110 is discharged to the external environment through the interactive port 120. Impact of internal and external moist fluids on the humidity inside the main body chamber 110 is comprehensively considered, thereby reducing the possibility of the internal and external moist fluids causing damage to the drive unit 230 of the fluid pumping mechanism 200 and the electronic device 300. In this way, content of the moist fluids in the main body chamber 110 is minimized, to prolong the service life of the oral care apparatus.

In practical applications, the interactive port 120 may be arranged at any position on the main housing 100, such that the water vapor inside the main body chamber 110 may be discharged to the external environment. A waterproof and breathable member may be provided on the interactive port 120 to prevent a liquid in the external environment from entering the main body chamber 110 through the interactive port 120. Considering that the liquid in the main body chamber 110 may be discharged to the external environment and to avoid entry of the external moist fluid, the interactive port 120 may be provided at the bottom of the main housing 100. For example, when the oral care apparatus is the liquid supply base station, the interactive port 120 may be provided on the lower cover 102. In this way, when there is a liquid in the main body chamber 110, the liquid may flow out of the interactive port 120 under the action of gravity, and the entry of the liquid in the external environment can also be avoided. Of course, to make it easier for the liquid in the main body chamber 110 to flow to the interactive port 120 and to flow out of the interactive port 120, an inner wall surface of the main body chamber 110 formed by the main housing 100 may also be provided with a guide slot, such that the liquid in the main body chamber 110 is guided to the interactive port 120 using the guide slot.

Regarding to specific implementation where at least part of space inside the main body chamber 110 communicates with the external environment through the interactive port 120, such that the moist fluid inside the main body chamber 110 is discharged to the external environment through the interactive port 120, the present disclosure provides two implementable embodiments for reference.

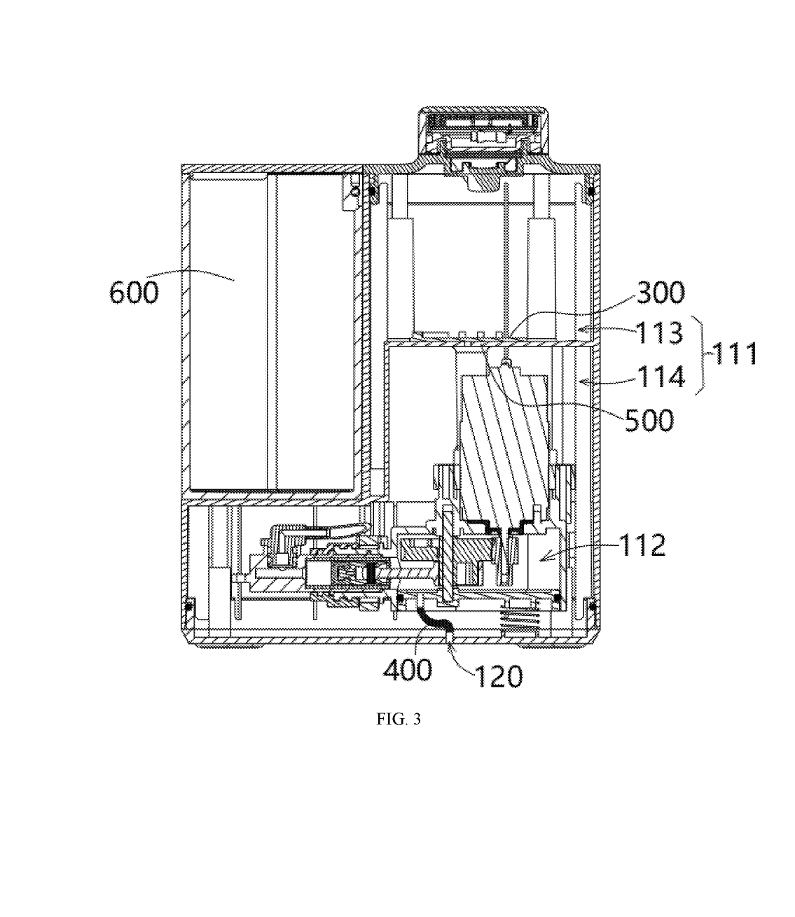

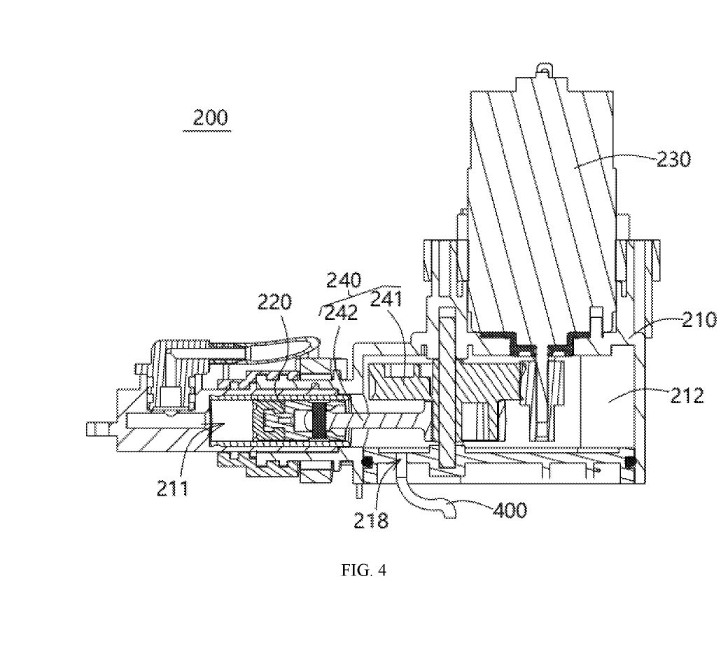

In Embodiment I, as shown in FIGS. 3 and 4, the fluid pumping mechanism 200 also includes an execution unit 220, a drive unit 230, and a transmission unit 240. The housing component 210 at least has an execution cavity 211 and a transmission cavity 212. Both the execution cavity 211 and the transmission cavity 212 are isolated and sealed from the first space 111, thereby preventing the moist fluids inside the execution cavity 211 and the transmission cavity 212 from directly flowing into the first space 111. The execution unit 220 is positioned within the execution cavity 211, and the transmission unit 240 is positioned within the transmission cavity 212 and partially extends into the execution cavity 211 to connect the execution unit 220. An output end of the drive unit 230 extends into the transmission cavity 212 and is connected to the execution unit 220 by means of the transmission unit 240, such that the drive unit 230 drives the execution unit 220 to move by means of the transmission unit 240, to pump a liquid from an inlet of the execution cavity 211 into the execution cavity 211 and discharge the liquid from an outlet of the execution cavity 211. The moist fluid generated by the fluid pumping mechanism 200 mainly comes from the liquid leaked into the transmission cavity 212 and the water vapor evaporated into the transmission cavity 212. With regard to this, in this embodiment the interactive port 120 communicates with the transmission cavity 212, such that the moist fluid generated by the fluid pumping mechanism 200 is discharged from the interactive port 120 to the external environment through the transmission cavity 212.

In this way, this embodiment is equivalent to directly discharging the moist fluid from a source to the external environment, preventing the moist fluid from flowing into the first space 111, and thus preventing the moist fluid from causing damage to the drive unit 230 of the fluid pumping mechanism 200 and the electronic device 300. Meanwhile, even though the moist fluid in the external environment enters the interactive port 120, the moist fluid from the external environment can be prevented from entering the first space 111 and from causing damage to the drive unit 230 of the fluid pumping mechanism 200 and the electronic device 300.

In practical applications, the fluid pumping mechanism 200 may be a pump body structure such as a piston pump or a diaphragm pump. Taking an example where the fluid pumping mechanism 200 is the piston pump, the execution unit 220 is a piston, and the drive unit 230 is a motor. The transmission unit 240 includes a gear set 241 and a connecting rod 242. The motor is connected to one end of the gear set 241, and the other end of the gear set 241 is connected to the piston through the connecting rod 242. In this way, the motor drives the transmission unit to convert a rotational motion into a reciprocating motion, to drive the piston to reciprocate and pump and squeeze out the liquid. Typically the oral care apparatus also includes a water tank 600, which is arranged outside the main body chamber 110. The inlet of the execution cavity 211 may communicate with the water tank 600 through a liquid inlet pipe, thereby preventing leakage of the moist fluid in the water tank 600 from causing damage to the drive unit 230 and the electronic device 300.

In one implementable embodiment, the housing component 210 is provided with a communication hole 218, where the communication hole 218 communicates with the interactive port 120 through a pipeline 400, and the communication hole 218 has a component along the direction of gravity. In this way, the moist fluid inside the transmission cavity 212 is discharged to the external environment through the communication hole 218, the pipeline 400, and the interactive port 120 in sequence.

The housing component 210 has a portion for enclosing and forming the transmission cavity 212, and the communication hole 218 is arranged at a bottom of this portion of the housing component 210 in the direction of gravity, and/or the interactive port 120 is arranged at the bottom of the main housing 100 in the direction of gravity. In this way, both the communication hole 218 and the interactive port 120 are positioned at a lowest point of a corresponding part, to discharge all the moist fluids in the transmission cavity 212 as much as possible, thereby reducing the possibility of causing damage to the electronic device 300 and the drive unit 230.

It should be noted that the direction of gravity defined in the present disclosure generally refers to the direction of gravity when the oral care apparatus is normally placed, or may be understood as the direction of gravity when a bottom surface of the main housing 100 is placed on a horizontal plane.

In Embodiment 2, as shown in FIG. 1, the interactive port 120 may communicate with the first space 111, such that the moist fluid generated in the fluid pumping mechanism 200 is discharged from the interactive port 120 to the external environment through the first space 111. Specifically, the water vapor formed by evaporation of the liquid adhering to the cylinder liner inside the fluid pumping mechanism 200 or the leaked liquid may first enter the transmission cavity 212 of the fluid pumping mechanism 200, then may leak into the first space 111 through the transmission cavity 212, and then may be discharged from the first space 111 to the external environment through the interactive port 120.

In practical applications, the execution cavity 211 and the transmission cavity 212 of the fluid pumping mechanism 200 may also be isolated and sealed from the first space 111, thereby preventing the moist fluids in the execution cavity 211 and the transmission cavity 212 from directly flowing into the first space 111. In this embodiment, the interactive port 120 communicates with the first space 111, such that the moist fluid in the first space 111 is discharged to the external environment through the interactive port 120 when the moist fluid in the execution cavity 211 and/or the transmission cavity 212 accidentally leaks into the first space 111. Reference may be made to the detailed description recorded in the above embodiments for the specific structure of the fluid pumping mechanism 200, which is not to be described in detail herein.

To further reduce the possibility of the moist fluid generated by the fluid pumping mechanism 200 causing damage to the drive unit 230 of the fluid pumping mechanism 200 and the electronic device 300, in one implementable embodiment, the housing component 210 of the fluid pumping mechanism 200 encloses to form a second space 112, where the execution cavity 211, the transmission cavity 212, the execution unit 220, and the transmission unit 240 of the fluid pumping mechanism 200 are positioned within the second space 112. In this way, it is equivalent to isolating the electronic device 300 from components that generate the moist fluid inside the fluid pumping mechanism 200. Therefore, when the interactive port 120 cannot efficiently discharge the moist fluid generated by the fluid pumping mechanism 200 to the external environment, the moist fluid remained in the main body chamber 110 cannot come into contact with the electronic device 300 and thus cannot cause damage to the electronic device 300.

As shown in FIG. 3, in an alternative embodiment, a partition board 500 may be arranged inside the main housing 100, and the partition board 500 is coupled with the main housing 100 to divide the first space 111 into a third space 113 and a fourth space 114 isolated and sealed from each other. The electronic device 300 is positioned within the third space 113, and the fluid pumping mechanism 200 is positioned within the fourth space 114. In this way, even though the moist fluid in the second space 112 leaks, the moist fluid only leaks into the fourth space 114. The partition board 500 can prevent the moist fluid from further leaking into the third space 113 and damaging the electronic device 300, thereby reducing the scope of damage caused by leakage.

Correspondingly, when the interactive port 120 communicates with the first space 111, the interactive port 120 should communicate with the third space 113 in the first space 111.

In this embodiment, the third space 113 and the fourth space 114 may be arranged in parallel along a horizontal direction. The fourth space 114 may also be positioned below the third space 113, which can further reduce the possibility of the liquid leaking into the third space 113 by utilizing the gravity of the liquid itself.

In practical applications, the partition board 500 may be designed integrally with the main housing 100, thereby simplifying assembly processes and ensuring the sealing performance between the partition board 500 and the main housing 100. The partition board 500 and the main housing 100 may also be separately designed and then connected to each other, and a sealing structure is provided between the partition board 500 and the main housing 100. A threading hole may be provided on the partition board 500 to facilitate a linear connection between the drive unit 230 of the fluid pumping mechanism 200 and at least part of the electronic device 300 through the threading hole, but the threading hole needs to be sealed to ensure that the third space 113 and the fourth space 114 are isolated and sealed from each other.

Of course, to further reduce the damage caused by the leakage of the moist fluid, both the electronic device 300 and the drive unit 230 of the fluid pumping mechanism 200 may be positioned within the third space 113, and remaining components of the fluid pumping mechanism 200 except the drive unit 230 are positioned within the fourth space 114. In this way, when the moist fluid in the second space 112 leaks, the partition board 500 can prevent the moist fluid from further leaking into the third space 113 and causing damage to the electronic device 300 and the drive unit 230, thereby further reducing the scope of damage caused by the leakage.

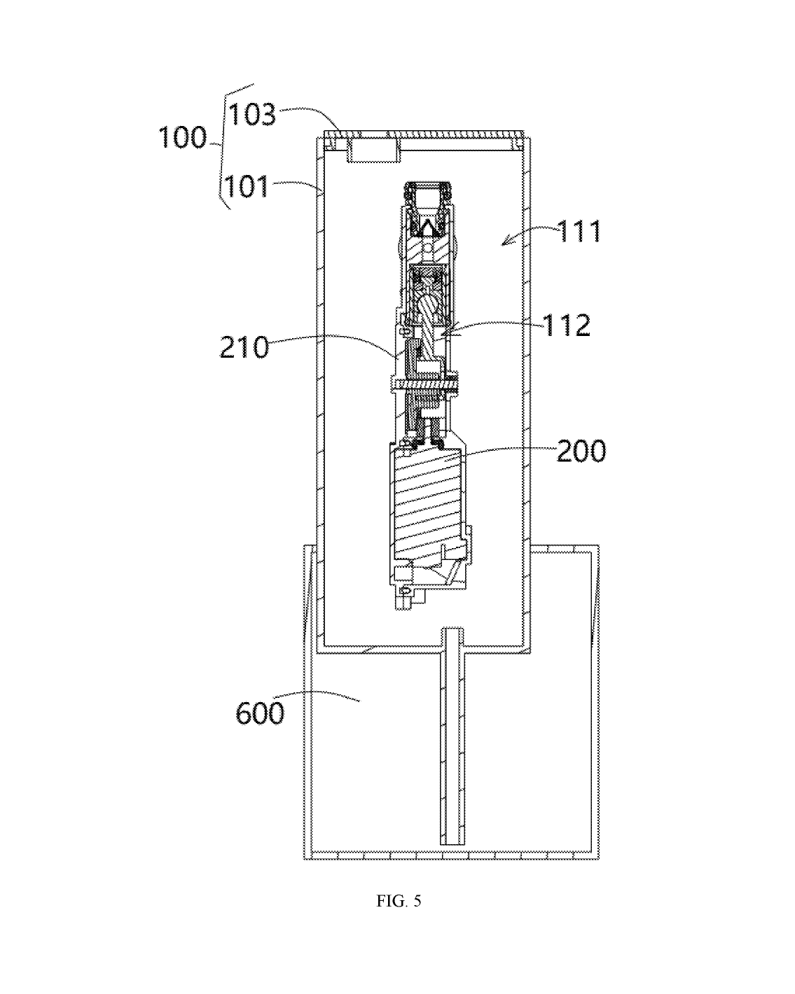

As shown in FIGS. 5 to 7, in another alternative embodiment, the housing component 210 may include a first housing piece 213 and a second housing piece 214 that are coupled to each other, and a pump body 219. The first housing piece 213, the second housing piece 214, and the pump body 219 jointly enclose to form the second space 112, and the second space 112 is divided into the execution cavity 211, the transmission cavity 212, and a drive cavity 215 for accommodating the drive unit 230, where the transmission cavity 212 is isolated and sealed from the drive cavity 215, to prevent the moisture fluid in the transmission cavity 212 from entering the drive cavity 215 and damaging the drive unit 230. Correspondingly, when the interactive port 120 communicates with the transmission cavity 212, the communication hole 218 may be provided on the first housing piece 213 or the second housing piece 214. In practical applications, the execution cavity 211 may be positioned in the pump body 219, and correspondingly, both the inlet and the outlet of the execution cavity 211 are formed on the pump body 219.

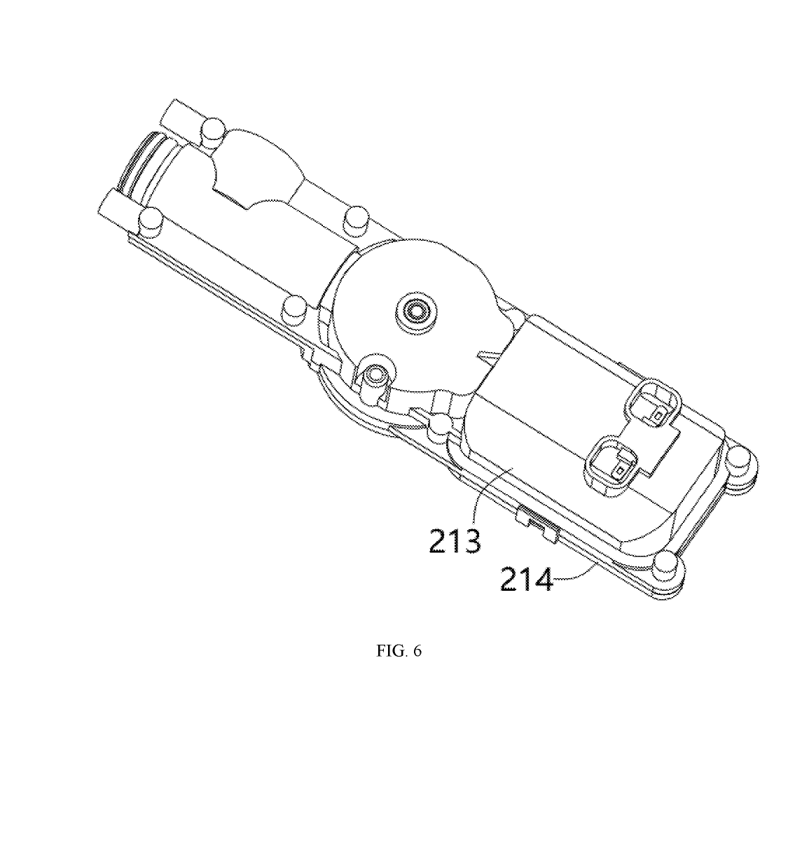

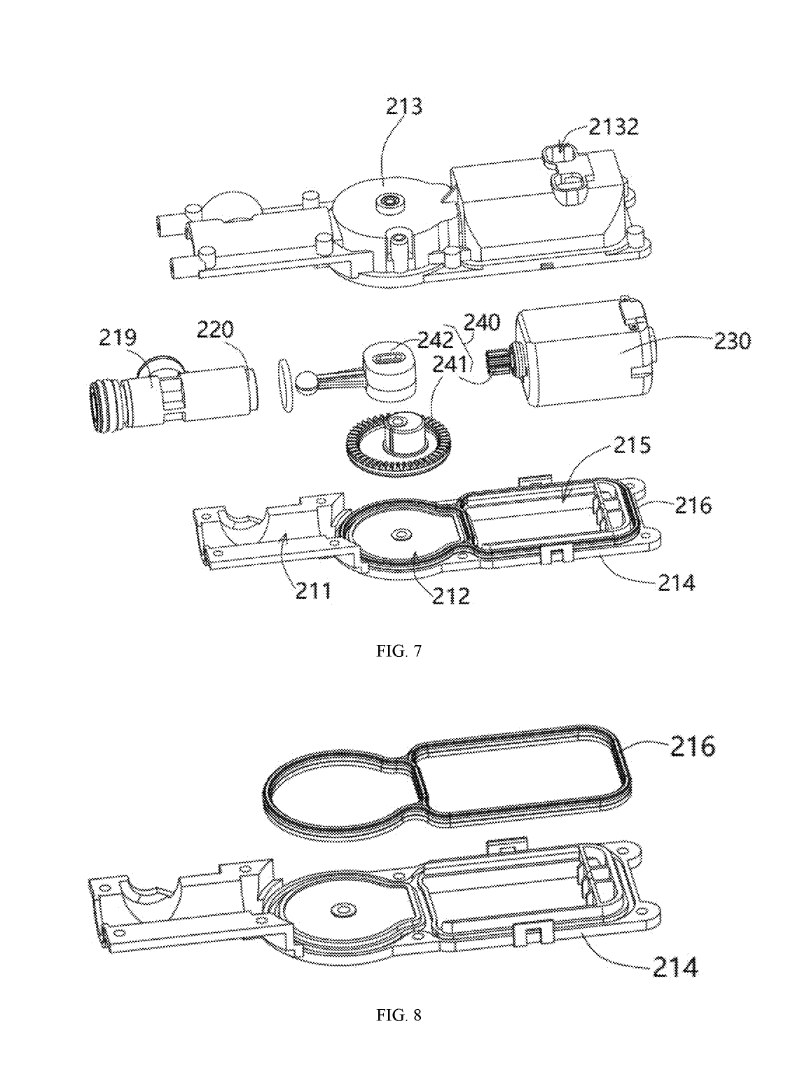

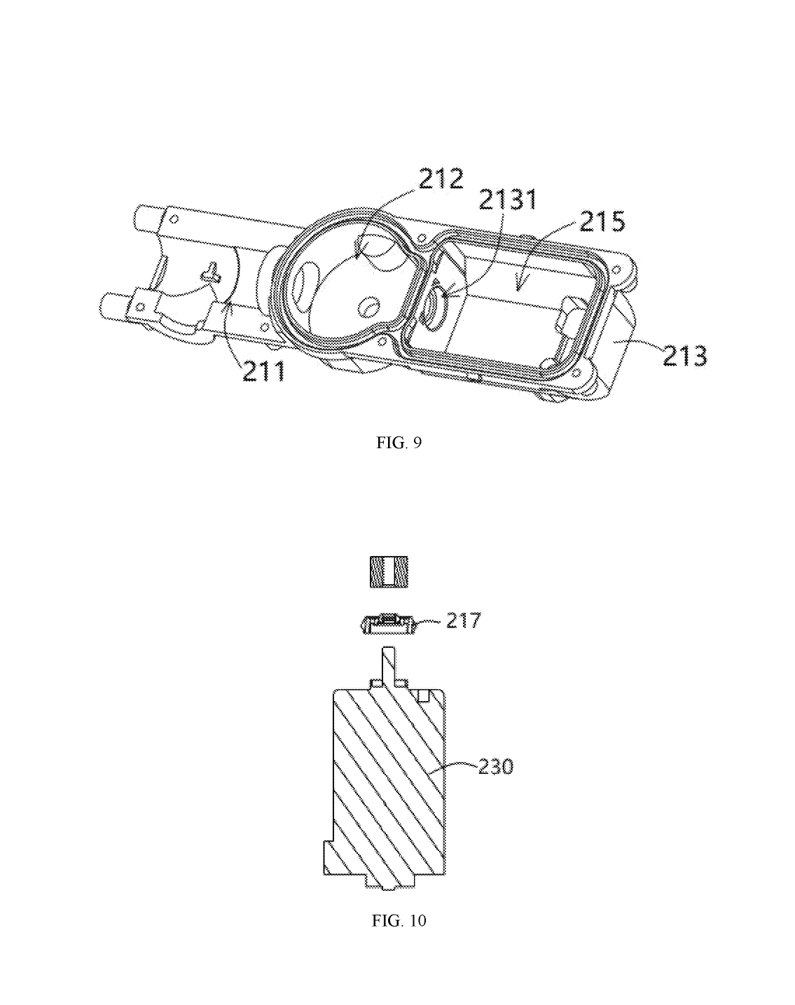

Regarding to the specific structure of isolation seal between the transmission cavity 212 and the drive cavity 215, as shown in FIGS. 7 to 10, in one implementable embodiment, a first sealing element 216 is provided at a splicing surface of the first housing piece 213 and/or the second housing piece 214, and the first sealing element 216 is arranged around the transmission cavity 212. Moreover, the first housing piece 213 or the second housing piece 214 is provided with a first clearance hole 2131. The output end of the drive unit 230 passes through the first clearance hole 2131 and extends into the transmission cavity 212, and a second sealing element 217 is filled between the output end and the first clearance hole 2131. In this way, the drive cavity 215 and the transmission cavity 212 are isolated and sealed from each other by means of the first sealing element 216 and the second sealing element 217, thereby preventing the moist fluid from leaking into the drive cavity 215 through the splicing surface of the first housing piece 213 and/or the second housing piece 214 or through the first clearance hole 2131.

Further, the first sealing element 216 may also be arranged around the drive cavity 215. Furthermore, considering that the drive unit 230 needs to be linearly connected to the electronic device 300 within the first space 111, the first housing piece 213 or the second housing piece 214 is provided with a wire harness connection hole 2132 communicating with the drive cavity 215, where a tab of the drive unit 230 is positioned at the wire harness connection hole 2132, and the tab of the drive unit 230 is connected to the electronic device 300 through the wire harness connection hole 2132, and the wire harness connection hole 2132 is filled with a sealant.

In this way, the first sealing element 216 may simultaneously seal a gap of the splicing surface of the transmission cavity 212 and a gap of the splicing surface of the drive cavity 215, to achieve “one piece with dual purposes” and reduce number of assemblies. Moreover, the first sealing element 216 and the sealant may also isolate and seal the drive cavity 215 from the first space 111. In this way, even though the moist fluid in the transmission cavity 212 leaks into the drive cavity 215 through the splicing surface of the first housing piece 213 and/or the second housing piece 214 or through the first clearance hole 2131, the sealing structure of the drive cavity 215 can limit the moist fluid within the drive cavity 215, thereby preventing faults from further spreading and further improving the waterproof effect.

In practical applications, the first sealing element 216 may be integrated with the first housing piece 213 or the second housing piece 214 by means of overmolding to form the housing component, thereby simplifying the assembly processes. Of course, the splicing surface of the first housing piece 213 and/or the second housing piece 214 may also be provided with an accommodating groove. The first sealing element 216 may be first pre-positioned and mounted in the accommodating groove, and then the first housing piece 213 is spliced and connected to the second housing piece 214.

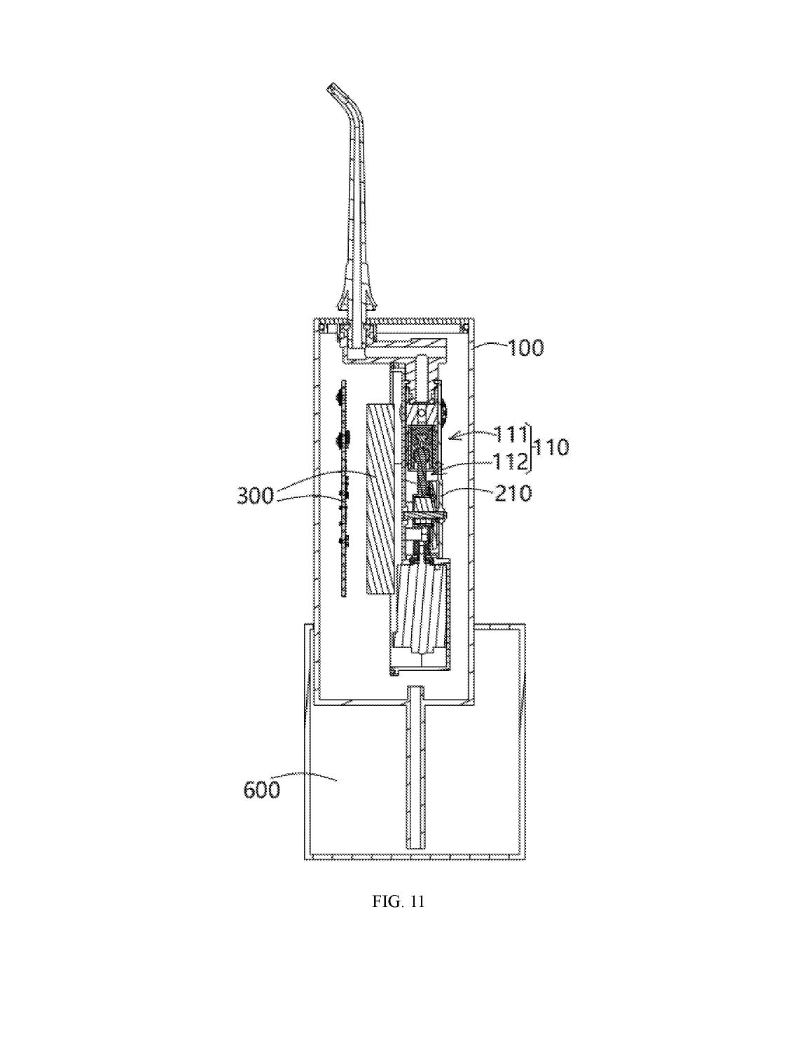

As shown in FIG. 11, in another alternative embodiment, the housing component 210 includes a first housing piece 213 and a second housing piece 214 coupled to each other, and a pump body 219. The first housing piece 213, the second housing piece 214, and the pump body 219 jointly enclose to form the second space 112, and the second space 112 is divided into the execution cavity 211 and the transmission cavity 212, where the drive unit 230 of the fluid pumping mechanism 200 is positioned within the first space 111. In this way, it is equivalent to providing dry-wet separation between the electronic device 300 or the drive unit 230 which are easily damaged by the moist fluid and the components of the fluid pumping mechanism 200 that generate the moist fluid. In one aspect, when the interactive port 120 cannot efficiently discharge the moist fluid generated by the fluid pumping mechanism 200 to the external environment, the moist fluid remained in the main body chamber 110 cannot come into contact with the electronic device 300 and the drive unit 230 and thus cannot cause damage to the electronic device 300 and the drive unit 230. In another aspect, the electronic device 300 and the drive unit 230 are positioned within the same space, and the electronic device 300 may be directly linearly connected to the drive unit 230 without the need for providing additional openings or sealing structures for a connecting harness, thus reducing production costs.

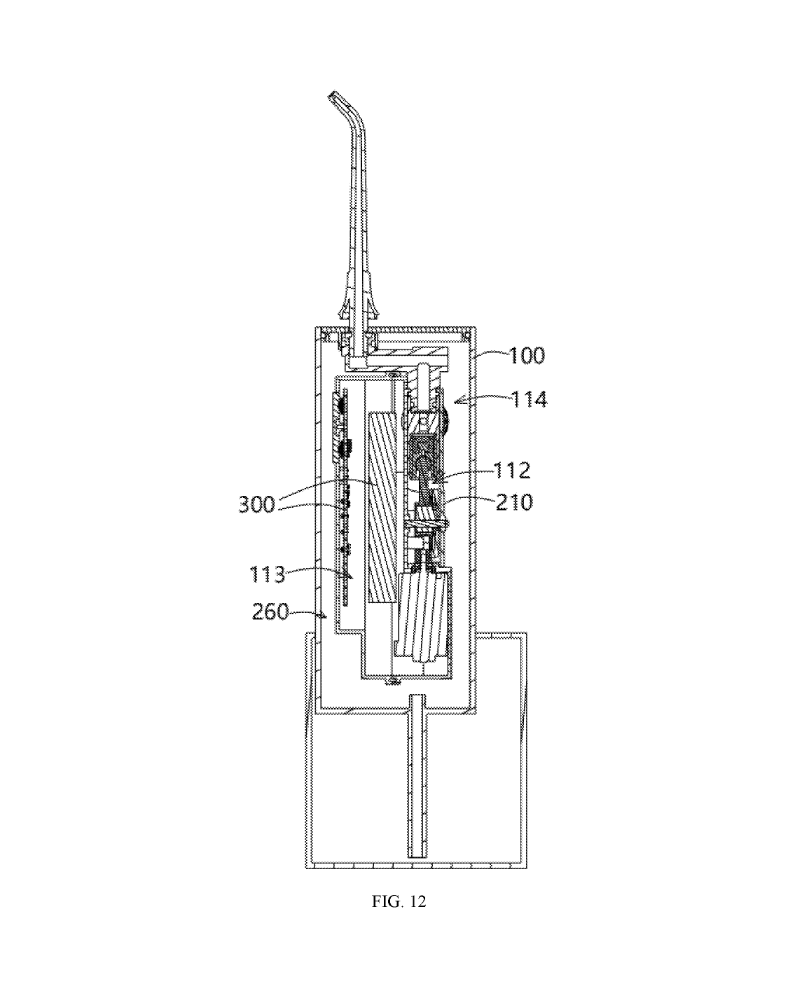

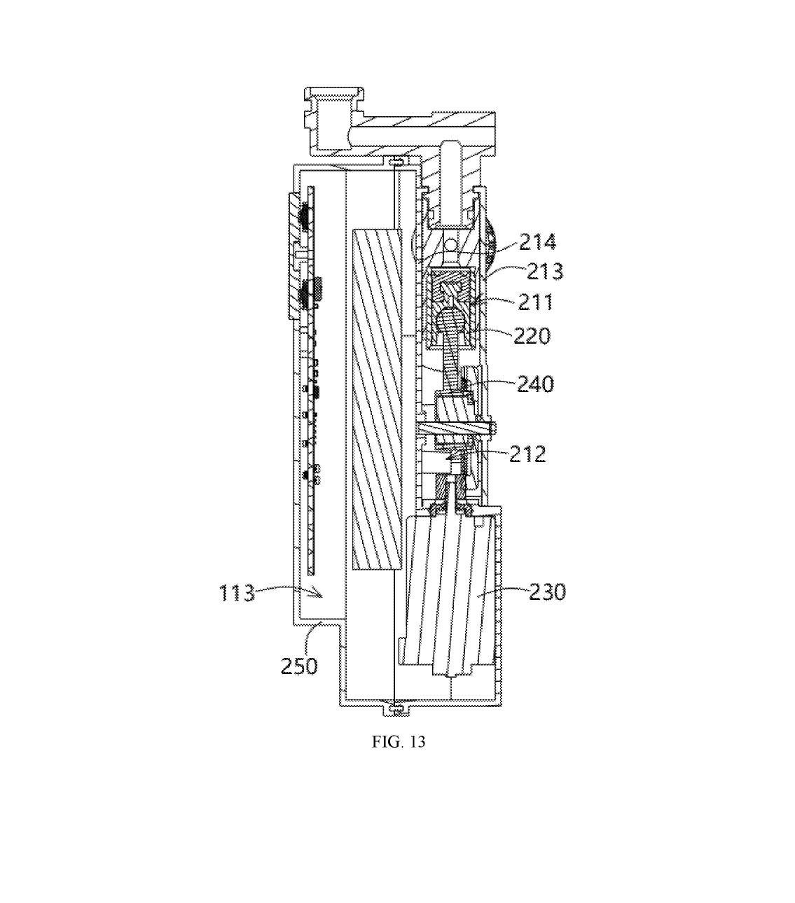

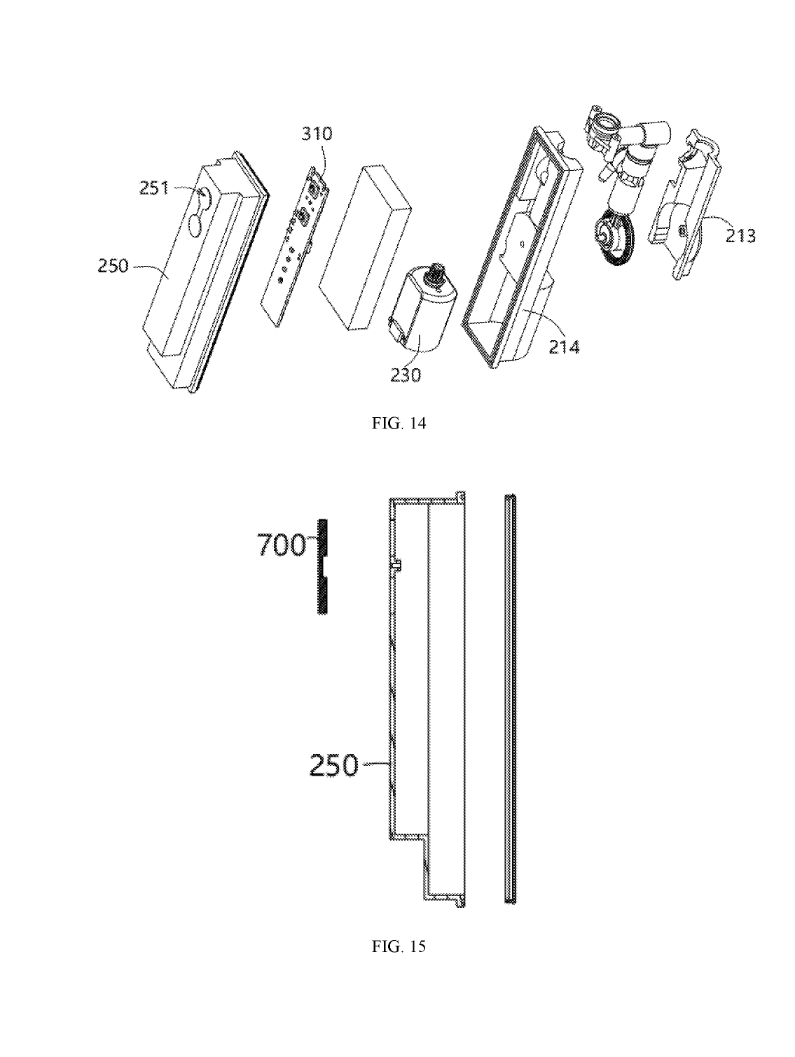

Further, as shown in FIGS. 12 and 13, the oral care apparatus also includes a third housing piece 250 positioned within the first space 111. The third housing piece 250 is coupled with the first housing piece 213 or the second housing piece 214 to enclose and form a sealed third space 113, where the electronic device 300 and the drive unit 230 are positioned within the third space 113. In this way, when the moist fluid in the second space 112 leaks, the sealing structure of the third space 113 can prevent the moist fluid from coming into contact with the electronic device 300 and the drive unit 230, thereby further reducing the possibility of causing damage to the electronic device 300 and the drive unit 230 by the moist fluid.

In this embodiment, an outer surface of an entirety formed by the third housing piece 250 and the housing component 210 encloses, together with the main housing 100, to form a fourth space 114, and the fourth space 114 may surround the second space 112 and the third space 113, such that the second space 112 and the third space 113 create a visual effect similar to suspension.

Correspondingly, when the interactive port 120 communicates with the first space 111, the interactive port 120 may communicate with the fourth space 114. In this way, by providing the third space 113, it is avoidable that the moist fluid causes any damage when it is discharged to the external environment through the interactive port 120.

In practical applications, the first sealing element 216 is provided at the splicing surface of the first housing piece 213 and/or the second housing piece 214. Moreover, the first housing piece 213 or the second housing piece 214 is provided with the first clearance hole 2131. The output end of the drive unit 230 passes through the first clearance hole 2131 and extends into the transmission cavity 212, and the second sealing element 217 is filled between the output end and the first clearance hole 2131. In this way, the transmission cavity 212 and the first space 111 are isolated and sealed from each other by means of the first sealing element 216 and the second sealing element 217, thereby preventing the moist fluid from leaking into the third space 113 through the splicing surface of the first housing piece 213 and/or the second housing piece 214 or through the first clearance hole 2131.

It is worth mentioning that in this embodiment, the first space 111 is divided into the third space 113 and the fourth space 114 that are isolated and sealed from each other. The water tank 600 for liquid supply and the liquid inlet pipe connecting the inlet of the execution cavity 211 may be arranged in the fourth space 114, such that in the event of leakage of the moist fluid due to accidental damage to the liquid inlet pipe, it is also avoidable that the moist fluid causes damage to the drive unit 230 and the electronic device 300 positioned within the third space 113.

Considering that a control button need to be provided on the main housing 100 of the oral care apparatus, and the control button needs to be pressed to come into contact with a button on the PCB board 310 in the third space 113, a keypad hole 251 also needs to be provided on the third housing piece 250. Correspondingly, the oral care apparatus may also include a keypad seal 700 coupled to the PCB board 310, and the keypad seal 700 seals the keypad hole 251 to prevent the moist fluid in the second space 112 from leaking into the third space 113 through the keypad hole 251.

The above improvement scheme not only is applicable to the oral care apparatus, but also may be applicable to any other apparatus with a fluid pumping mechanism.

Specifically, based on the same inventive concept, the present disclosure also provides an apparatus with a fluid pumping mechanism, which includes a main housing 100, a fluid pumping mechanism 200, and an electronic device 300. The main housing 100 has a sealed main body chamber 110, and the fluid pumping mechanism 200 is arranged inside the main body chamber 110. The fluid pumping mechanism 200 includes a housing component 210, where an outer surface of the housing component 210 and the main housing 100 enclose to form a first space 111, and the electronic device 300 is arranged within the first space 111. The main housing 100 is provided with an interactive port 120, and at least part of space inside the main body chamber 110 communicates with external environment through the interactive port 120, such that the moist fluid inside the main body chamber 110 is discharged to the external environment through the interactive port 120.

It should be pointed out that reference may be made to the detailed description recorded in the above embodiments for the specific structures of the main housing 100, the fluid pumping mechanism 200, the electronic device 300, and the interactive port 120, which are not to be described in detail herein.

The terms such as "upper” and "lower” for describing relative positional relationships of various structures in the drawings are merely for the purpose of concise description rather than limiting the implementable scope of the present disclosure. The changes or adjustments of the relative relationship without a substantial modification to the technical solutions are regarded as being covered by the implementable scope of the present disclosure.

It is to be noted that in the present disclosure, unless specified or limited otherwise, a first feature “on” or “below” a second feature may include an embodiment in which the first feature is in direct contact with the second feature, and may also include an embodiment in which the first feature and the second feature are in indirect contact via an intermediary. Furthermore, a first feature “on,” “above,” or “on top of” a second feature may include an embodiment in which the first feature is right or obliquely “on,” “above,” or “on top of” the second feature, or just means that the first feature is at a height higher than that of the second feature. A first feature “below,” “under,” or “on bottom of” a second feature may include an embodiment in which the first feature is right or obliquely “below,” “under,” or “on bottom of” the second feature, or just means that the first feature is at a height lower than that of the second feature.

In addition, in the present disclosure, unless specified or limited otherwise, terms “mounted”, “connected”, “coupled”, “fixed” and so on should be understood in a broad sense, which may be, for example, a fixed connection, a detachable connection or integrated connection, a direct connection or indirect connection by means of an intermediary, an internal communication between two elements or an interaction relationship between two elements. The specific significations of the above terms in the present disclosure may be understood in the light of specific conditions by persons of ordinary skill in the art.

Reference throughout this specification to the terms “an embodiment,” “some embodiments,” “an exemplary embodiment,” “an example,” “a specific example,” or “some examples,” means that a specific feature, structure, material, or characteristic described in connection with the embodiment or example is included in at least one embodiment or example of the present disclosure. The schematic representation of the above terms throughout this specification is not necessarily referring to the same embodiment or example. Furthermore, the specific features, structures, materials, or characteristics set forth may be combined in any suitable manner in one or more embodiments or examples.

Finally, it is to be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, which does not make corresponding technical solutions in essence depart from the scope of the technical solutions of the embodiments of the present disclosure.

What is claimed is:

1. An oral care apparatus at least comprising:
a main housing (100) having a main body chamber (110);
a fluid pumping mechanism (200) arranged inside the main body chamber (110), the fluid pumping mechanism (200) comprising a housing component (210), an outer surface of the housing component (210) and the main housing (100) enclosing to form a first space (111); and
an electronic device (300) arranged within the first space (111);
wherein the main housing (100) is provided with an interactive port (120), and at least part of space inside the main body chamber (110) communicates with external environment through the interactive port (120), such that a moist fluid inside the main body chamber (110) is discharged to the external environment through the interactive port (120).

2. The oral care apparatus according to claim 1, wherein the interactive port (120) communicates with the first space (111), such that the moist fluid generated by the fluid pumping mechanism (200) is discharged from the interactive port (120) to the external environment through the first space (111).

3. The oral care apparatus according to claim 1, wherein the fluid pumping mechanism (200) further comprises an execution unit (220), a drive unit (230), and a transmission unit (240);
the housing component (210) at least has an execution cavity (211) and a transmission cavity (212), both the execution cavity (211) and the transmission cavity (212) being isolated and sealed from the first space (111);
the execution unit (220) is positioned within the execution cavity (211), and the transmission unit (240) is positioned within the transmission cavity (212) and partially extends into the execution cavity (211);
an output end of the drive unit (230) extends into the transmission cavity (212) and is connected to the execution unit (220) by means of the transmission unit (240); and
the transmission cavity (212) communicates with the interactive port (120), such that the moist fluid generated by the fluid pumping mechanism (200) is discharged from the interactive port (120) to the external environment through the transmission cavity (212).

4. The oral care apparatus according to claim 3, wherein the housing component (210) is provided with a communication hole (218), the communication hole (218) communicates with the interactive port (120) through a pipeline (400), and the communication hole (218) has a component along a direction of gravity.

5. The oral care apparatus according to claim 4, wherein the communication hole (218) is arranged at a bottom of portion of the housing component (210) for forming the transmission cavity (212) along the direction of gravity, and/or the interactive port (120) is arranged at the bottom of the main housing (100) along the direction of gravity.

6. The oral care apparatus according to claim 1, wherein the housing component (210) of the fluid pumping mechanism (200) encloses to form a second space (112), and the execution cavity (211), the transmission cavity (212), the execution unit (220), and the transmission unit (240) of the fluid pumping mechanism (200) are positioned within the second space (112).

7. The oral care apparatus according to claim 6, wherein a partition board (500) is arranged inside the main housing (100), and the partition board (500) is coupled with the main housing (100) to divide the first space (111) into a third space (113) and a fourth space (114) isolated and sealed from each other; and
the electronic device (300) is positioned within the third space (113), and the fluid pumping mechanism (200) is positioned within the fourth space (114).

8. The oral care apparatus according to claim 6, wherein a partition board (500) is arranged inside the main housing (100) to divide the first space (111) into a third space (113) and a fourth space (114) isolated and sealed from each other; and
the electronic device (300) and the drive unit (230) of the fluid pumping mechanism (200) are positioned within the third space (113), and remaining components of the fluid pumping mechanism (200) except the drive unit (230) are positioned within the fourth space (114).

9. The oral care apparatus according to claim 6, wherein the housing component (210) comprises a first housing piece (213) and a second housing piece (214) coupled to each other, and a pump body (219); and
the first housing piece (213), the second housing piece (214), and the pump body (219) jointly enclose to form the second space (112), and the second space (112) is divided into the execution cavity (211), the transmission cavity (212), and a drive cavity (215) for accommodating the drive unit (230), the transmission cavity (212) being isolated and sealed from the drive cavity (215).

10. The oral care apparatus according to claim 9, wherein a first sealing element (216) is provided at a splicing surface of the first housing piece (213) and/or the second housing piece (214), and the first sealing element (216) is arranged around the transmission cavity (212); and
the first housing piece (213) or the second housing piece (214) is provided with a first clearance hole (2131), and the output end of the drive unit (230) passes through the first clearance hole (2131) and extends into the transmission cavity (212), and a second sealing element (217) is filled between the output end and the first clearance hole (2131).

11. The oral care apparatus according to claim 10, wherein the first sealing element (216) is further arranged around the drive cavity (215); and
the first housing piece (213) or the second housing piece (214) is provided with a wire harness connection hole (2132) communicating with the drive cavity (215), and the wire harness connection hole (2132) is filled with a sealant.

12. The oral care apparatus according to claim 6, wherein the housing component (210) comprises a first housing piece (213) and a second housing piece (214) coupled to each other, and a pump body (219); and
the first housing piece (213), the second housing piece (214), and the pump body (219) jointly enclose to form the second space (112), and the second space (112) is divided into the execution cavity (211) and the transmission cavity (212), the drive unit (230) of the fluid pumping mechanism (200) being positioned within the first space (111).

13. The oral care apparatus according to claim 12, further comprising a third housing piece (250) positioned within the first space (111), wherein
the third housing piece (250) is coupled with the first housing piece (213) or the second housing piece (214) to enclose and form a sealed third space (113), the electronic device (300) and the drive unit (230) being positioned within the third space (113).

14. The oral care apparatus according to claim 13, wherein an outer surface of an entirety formed by the third housing piece (250) and the housing component (210) encloses, together with the main housing (100), to form a fourth space (114), and the fourth space (114) surrounds the second space (112) and the third space (113).

15. The oral care apparatus according to claim 13, wherein the third housing piece (250) is provided with a keypad hole (251); and
the electronic device (300) comprises a PCB (printed circuit board) board (310), and the oral care apparatus further comprises a keypad seal(700) coupled to the PCB board (310), and the keypad seal(700) seals the keypad hole (251).

16. The oral care apparatus according to claim 1, wherein the interactive port (120) is provided with a waterproof and breathable member.

17. An apparatus with a fluid pumping mechanism comprising:
a main housing (100) having a main body chamber (110);
a fluid pumping mechanism (200) arranged inside the main body chamber (110), the fluid pumping mechanism (200) comprising a housing component (210), an outer surface of the housing component (210) and the main housing (100) enclosing to form a first space (111); and
an electronic device (300) arranged within the first space (111);
wherein the main housing (100) is provided with an interactive port (120), and at least part of space inside the main body chamber (110) communicates with external environment through the interactive port (120), such that a moist fluid inside the main body chamber (110) is discharged to the external environment through the interactive port (120).
